(19) United States
(12) Patent Application Publication
(10) Pub. No.: US 2007/0272627 A1
(43) Pub. Date: Nov. 29, 2007

(54) Use of inert, Porous Materials in Order to Reduce the Salt Content in Aqueous Solutions, and Method and Device Therefor

(76) Inventor: Antonio Giangrasso, Nurnberg (DE)

Correspondence Address: LAHIVE & COCKFIELD, LLP, ONE POST OFFICE SQUARE, BOSTON, MA, 02109-2127, US

(21) Appl. No.: 10/566,192

(22) PCT Filed: Jul. 27, 2004
(86) PCT No.: PCT/EP04/08401

§ 371 Date: Mar. 8, 2007

(30) Foreign Application Priority Data
Jul. 29, 2003 (DE) 10334514.0

(51) Int. Cl. B01J 20/28; C02F 1/10

(52) U.S. Cl. 210/774; 210/150; 428/220

(57) ABSTRACT

The present invention relates to the use of an inert porous material for desalination of water and in particular of sea water. In the method according to the invention, the inert porous material is impregnated with the saline water and brought into contact with dry air, which becomes enriched with water. This water-enriched air is cooled and the water it contains is condensed out and collected. The present invention also relates to an apparatus that is suitable for carrying out the method according to the invention.

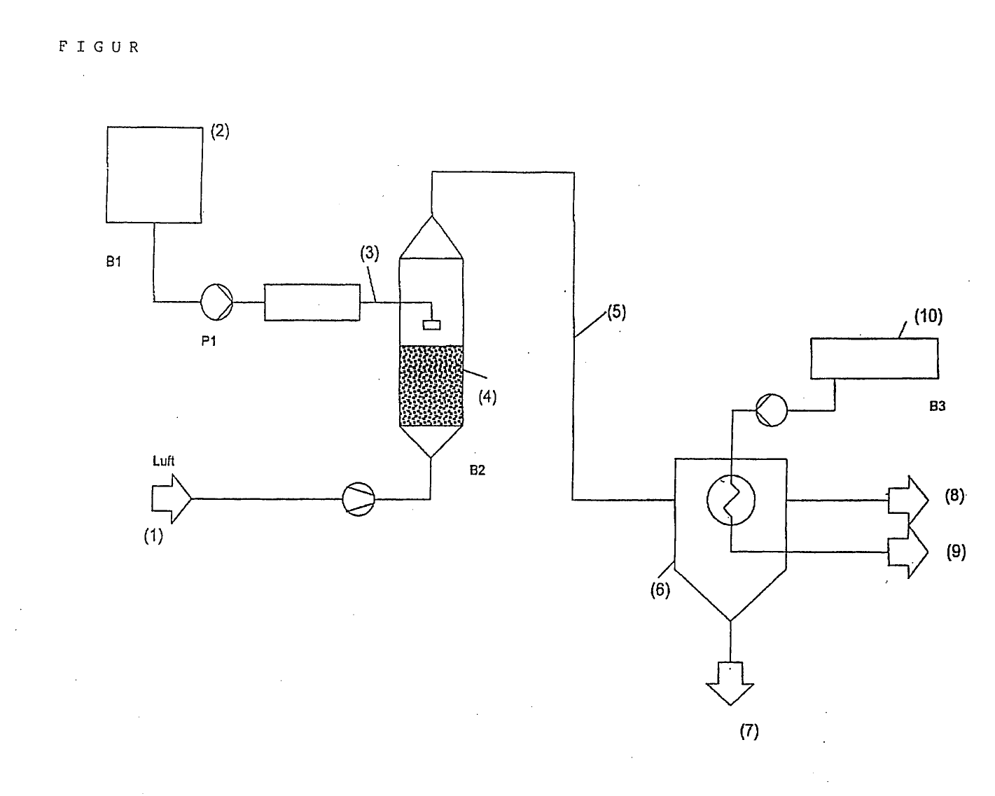

### SUBJECT MATTER OF THE INVENTION

The present invention relates to the use of inert porous materials for the reduction of the salt content in aqueous solutions and in particular for the desalination of sea water. A further object of the present invention is a corresponding method using these materials. In addition, the present invention relates to an apparatus that may be used in the method according to the invention.

### PRIOR ART

Reverse osmosis and evaporation of saline water are known as methods for desalination of (sea) water. A disadvantage, however, is the high energy consumption of these methods. For instance, in the osmotic method, a pressure of more than 50 bar must be applied and for evaporation of water, the thermal energy required to be consumed is 2200 kJ/kg water.

From DE 100 22 798, inert porous materials for storing water are known, which have a porosity of more than 60% and pores of which over 70% have a pore size of between 0.1 μm and 15 μm. The grains typically have a size of between 1 and 15 mm, and in its bulk form, the material has a bulk density of between 0.2 g/cm³ and 1.0 g/cm³ and a bulk surface of between 350 m²/l and 1500 m²/l. DE 100 22 798 does not teach, however, that these materials can be used for desalination of sea water.

It is an aim of the present invention to provide a method and a suitable apparatus for reducing the salt content in aqueous solutions and in particular for desalinating sea water, whereby compared with the prior art methods, less energy has to be expended.

### SUMMARY OF THE INVENTION

The above aim is fulfilled through the use of an inert porous material, as described in claim 1, for the reduction of the salt content of aqueous solutions. The dependent claims 2 to 9 concern preferred embodiments of such a material.

A further object of the invention is a method for reducing the salt content (desalination) of aqueous solutions using an inert porous material of this type, as described in the independent claim 10. The preferred embodiments of the method according to the invention are disclosed in claims 11 to 13.

An apparatus suitable for carrying out the method according to the invention is disclosed, finally, in claim 14. The preferred embodiments of this apparatus are contained in claims 15 and 16.

### BRIEF DESCRIPTION OF THE DRAWING

The FIGURE shows schematically the sequence of the method according to the invention.

### DETAILED DESCRIPTION OF THE INVENTION

1. Definitions

1.1 An “inert” material within the meaning of the present invention is taken to be a material that is neither soluble nor undergoes chemical reactions in water or aqueous solutions. In particular, the material is neither water-soluble, nor chemically reactive under the operating conditions of the method according to the invention.

1.2 Where not expressly stated, the present description uses the terms “pore”, “porous” and “porosity” in the sense of open porosity. These terms relate therefore to pores that are accessible from outside.

1.3 The “specific surface” is determined via the nitrogen adsorption according to the BET method as per DIN 66131.

1.4 The accessible (open) “porosity” is determined by mercury porosimetry as per DIN 66133.

1.5 The “grain size” is determined by screen analysis as per DIN 53477.

1.6 “Porosity” is defined by the formula (I)
P=V*100%/(1/S+V) (I)

where P is the porosity (cm³/g), S is the true density (g/cm³) and V is the specific pore volume (cm³/g)

1.7 The “specific pore volume” is determined using mercury porosimetry according to DIN 66133. When measuring the specific pore volume by mercury porosimetry, the quantity of mercury penetrating into the sample is determined, together with the pressure required. Using these data, given the known capillary pressure of mercury, the pore volume and pore size are determined. Based on the fact that mercury can only penetrate into accessible pores, it is only the open porosity that is detected by this measurement.

1.8 The “true density” (solid density) is obtained by measurement according to DIN 66137-2

1.9 The “water absorption capacity” of the porous material is determined according to DIN 19683.

1.10 The “volume increase” of the material in the presence of water is determined by measuring the increase in particle diameter by means of screen analysis before and after soaking the material with water to saturation.

2. Porous Material

The chemical structure and composition of the inert, porous material are not specified in greater detail. However, it is necessary that the material have the properties set out in claim 1.

For carrying out the method according to the invention, it is of decisive importance to select a material with which a high level of efficiency will be achieved. For this purpose, a large specific surface is required, and this is adjusted via the pore volume and the pore size. The principle applies that the smaller the pores are, the larger is the surface. At the same time, however, smaller pores have larger capillary forces, so that water is more firmly bound in the porous material and cannot be evaporated so easily. Pore size and specific surface are therefore contrary variables and an ideal range must be found where the surface is large enough such that a very high efficiency is achieved, but simultaneously the capillary forces of the pores are not so large that the transition of the water into the gaseous phase requires a great deal of energy. The porous material is further used in the form of grains and is employed in the method according to the invention as bulk material. If the grains are too small, the pressure loss (flow resistance) becomes too high, whilst if the grains are too large, the contact time of the porous material with the air is very short and therefore little water transfers to the gaseous phase.

According to the invention, the above requirements are fulfilled by means of an inert material having the following characteristics:
a specific surface of between 10 m²/l and 10,000 m²/l,
a porosity of between 10% and 80%,
pores of which at least 50% have a pore size of between 0.1 μm and 1000 μm,
grains of which more than 50% have a grain size of between 0.1 mm and 50 mm, and
a water absorption capacity of at least 10% of its own weight.

Materials are preferred whose specific surface is between 250 m²/l and 2500 m²/l. Equally, materials are advantageously used in which at least 80% of the pores lie within a size range between 0.5 μm and 100 μm. It is also preferred if 90% of the material has a grain size of between 0.1 mm and 50 mm. Also preferred is the use of a material whose (open) porosity lies between 40% and 80%.

Preferably the material is a non-metallic inorganic material. Particularly preferred are ceramic materials, which are distinguished by their high porosity and chemical stability.

A particularly preferred material is disclosed in DE 100 22 798.

As further materials suitable for carrying out the method according to the invention, zeolite, activated carbon, granulated clay, porous plastics, sponges (natural and artificial) and porous siliceous minerals are given.

If the method according to the invention is carried out such that the material impregnated with water has air passed through it, it is also preferable to select the porous material such that no pressure fall occurs in the bulk material. This property is fulfilled, for instance, when a granular material is used whose individual grains are formed as irregularly as possible. A spiked structure for the material is particularly advantageous in this context.

It is also helpful if the material has the narrowest possible grain size distribution, so that the gaps formed between the grains cannot be filled by smaller constituent parts of the material.

Advantageously, for achievement of the low pressure fall, the volume increase of the inert material in the presence of water should also be less than 10%. Preferable are materials without any volume increase.

3. Method

The present invention relates to a method that enables the reduction of the salt content in aqueous solutions. The principle underlying the present invention is based on an increase of the surface area of the aqueous solution that can be brought into contact with the air, in order thereby to ensure rapid evaporation of the water without a great additional energy input. At the same time, it is advantageous to maintain the flow-through capability of the impregnated porous material, in order that the energy requirement for overcoming the pressure drop occurring on flow-through of the material may be kept within reasonable limits.

The substantial steps of this method are

(a) bringing the saline aqueous solution into contact with the inert porous material defined in one or more of the claims 1 to 10;

(b) bringing the porous material impregnated with the aqueous solution into contact with air at a temperature of between 10° C. and 80° C.;

(c) transporting the enriched air from step (b) into a condensation chamber, whereby the air is cooled to between 5° C. and 40° C., but at least by 5° C.;

(d) condensing, in the condensation chamber, of the water absorbed in the air; and

(e) collecting the condensed water.

3.1 In step (a), the porous material described above is impregnated with the saline aqueous solution.

The quantity of aqueous solution fed in is fundamentally not specified. It is ideally chosen such that the total surface of the porous material that can be reached by the air is wet throughout the entire running duration of the method. In particular, on continuous operation of the method, the quantity fed in should correspond to the quantity of water that is absorbed by the air and carried away.

The quantity of saline aqueous solution should also preferably not be so high that the entire quantity cannot be absorbed by the porous material. Such a supersaturation of the porous material may lead to a reduction in the contact surface between the aqueous solution and the air, and thereby to a reduction in the efficiency of the method.

The feeding in of the aqueous solution may be carried out either continuously or discontinuously. Care should preferably be taken that no region of the material dries out completely, since this leads to the crystallisation of salt on the material. In such an event, it is possible, however, to remove crystallised-out salt by rinsing with saline or with salt-free water.

In a preferred embodiment of the method according to the invention, the aqueous solution to be fed in is warmed by solar radiation before or during step (a).

3.2 In step (b), the material impregnated with the aqueous solution is brought into contact with air, in order that the water is absorbed by the air.

It is possible either to guide the air over the impregnated material, or to feed it through a bed of the impregnated porous material. The latter version has the advantage that a larger contact area of air/porous material may be achieved per unit area of the system, so that the method may be made more efficient. The flow over the impregnated porous material, however, should be marked by a lower degree of complexity in the equipment. Furthermore, in this event, an increased energy requirement for overcoming the pressure drop is not to be expected, as it would be on passing air through particularly compact beds.

The temperature of the air in this step lies between 10° C. and 80° C., and preferably between 30° C. and 60° C. Fundamentally, the temperature of the air should be chosen to be as high as possible, in order thereby to maximise the evaporation rate and the total quantity of water absorbed in the air. On the other hand, separate heating of the air requires additional energy, which has a negative impact on the energy balance of the overall method. Heating of this type is therefore not preferable. It is preferable, however, to warm the air to be used by solar irradiation before or during step (b).

It is favourable to use the driest possible air for the method. However, additional drying steps have a negative influence on the energy balance and are therefore not preferable. Rather, it is preferable to use ambient air without further pre-treatment.

The air is preferably fed at a flow rate of between 0.1 m/s and 100 m/s, and more preferably yet at a flow rate of between 2 m/s and 50 m/s over or through the impregnated porous material. The optimum flow rate is determined by the size and geometry of the contact surface, the air humidity and the temperature of the fed-in air, and by the temperature of the aqueous solution. It should be chosen such that an optimum compromise is achieved with regard to the largest possible quantity of water absorbed by the air and the smallest possible energy consumption required for accelerating the air.

3.3 In step (c), the air enriched with water is fed into a condensation chamber in which the water is precipitated out of the air in the subsequent step (d).

A spatial separation of the condensation chamber from the site where steps (a) and (b) are carried out is necessary in order to be able to bring about cooling of the enriched air, and in order to be able to separate out the salt-free or salt-poor water from the fed-in water.

For condensing out the water, it is necessary to cool the enriched air by at least 5° C. Furthermore in the condensation chamber, a temperature of between 5° C. and 40° C. should prevail. Suitable condensation temperatures may readily be read off by a person skilled in the art knowing the content of absorbed water in the air from the Mollier diagram known to a person skilled in the art.

In order to determine the content of water absorbed in the air, it is advantageous to provide a measuring device for determining the air humidity before the condensation chamber.

The cooling may take place via a heat exchanger. It is also preferable to place the condensation chamber in the ground so that the directly adjacent ground region is able to absorb heat from the system and to conduct it away.

The condensation is carried out in conventional condensation apparatus.

3.4 In step (e), the condensed-out water, which has a reduced salt content, is collected. It is then further processed depending upon the intended use of the water, placed in containers and/or transported away. For instance, it is necessary, for the use of the extracted water as drinking water, to remineralise it by dissolving suitable quantities of mineral salts in the water. The salts to be used and their quantities are well known to a person skilled in the art.

4. Apparatus

The apparatus for carrying out the method according to the invention comprises a container (4) for accommodating the porous material, a condensation chamber (6) and a conduit (5) linking the container (4) to the condensation chamber (6). A cooling medium is fed from the reservoir (10) through the condensation chamber (6) to the return (9). The reference number (8) identifies the air exit.

4.1 The container (4) comprises an inlet opening for the dry air, an outlet opening for the air enriched with water, and a device for feeding in the aqueous solution to the porous material contained in the container (4).

The geometry and spatial arrangement of the container (4) is not stipulated in greater detail. What is suitable, for instance, is the use of a pipe-shaped container (4), which may be arranged either horizontally or vertically. When selecting a suitable container (4), both the complexity of the apparatus and the associated costs, as well as optimisation of the parameters relevant to the process (maximum air/water contact area, minimum pressure loss) should be considered.

The material of the container (4) is also not specified, although it is a precondition that the material is resistant to the saline aqueous solution and particularly does not corrode.

4.2 The connection (5) of the container (4) and the condensation chamber (6) is also subject to the requirement only that it is made from a stable material.

4.3 The condensation chamber (6) is also not specified more precisely with regard to its design, provided it is ensured that it is suitable for condensing out the water contained in the air. The condensation devices usable for this are described in greater detail above in section 3.3.

A particularly favourable design of the apparatus according to the invention is characterised in that the condensation chamber (6) is designed such that it may be arranged under the ground surface in direct contact with the adjoining earth, since in this case the heat of condensation may be conducted away into the adjoining earth and the cooling of the enriched air stream from step (b) is enabled or facilitated by a lower ambient temperature of the adjoining earth.

4.4 Nor are any particular requirements placed on the vessel for collecting the water (7), apart from the requisite stability of the material.

4.5 It may also be advantageous to provide a supply container (2) for the saline aqueous solution linked via a feed conduit and a control valve to the feed device.

As far as the apparatus is intended for operation in a sunny region, it may be particularly advantageous to design the supply container (2), the feed conduit (3) and the container (4) for the porous material such that maximum warming of the water by solar radiation takes place. In this regard, in particular, a large surface facing towards the sun and its dark coloration are advantageous. Alternatively, the surface may be designed transparent and the surface remote from the sun on the other side of the water may be darkly coloured.

4.6 The air to be fed in must be accelerated in order to achieve the flow rates striven for in step (b). For this purpose, a conventional blower (1) is suitable. It is also conceivable to achieve the required flow rate by means of thermal convection effects.

The method described above and the corresponding apparatus are particularly well suited to reducing the salt content of (i.e. desalinating) aqueous solutions, such as sea water without a large energy expenditure being necessary, which is a disadvantage of known methods.

1. Use of an inert material with a specific surface of between 10 m²/l and 10,000 m²/l, with a porosity of between 10% and 80%, with pores of which at least 50% have a pore size of between 0.1 μm and 1000 μm, with grains of which more than 50% have a grain size of between 0.1 mm and 50 mm, and with a water absorption capacity of at least 10% of its own weight, for reducing the salt content in aqueous solutions.

2. Use according to claim 1, whereby the specific surface of the material is between 250 m²/l and 2500 m²/l.

3. Use according to claim 1, whereby at least 80% of the pores have a pore size of between 0.5 μm and 100 μm.

4. Use according to claim 1, whereby at least 90% of the grains have a grain size of between 0.1 mm and 50 mm.

5. Use according to claim 1, whereby the open porosity of the material is between 40% and 80%.

6. Use according to claim 1, whereby the inert material is a non-metallic inorganic material.

7. Use according to claim 6, whereby the inert material is a ceramic material.

8. Use according to claim 1, whereby the volume increase of the inert material in the presence of water is less than 10%.

9. Use according to claim 1, whereby the inert material has grains with an irregular form.

10. Method for reducing the salt content in aqueous solutions, comprising the steps
(a) bringing the saline aqueous solution into contact with the inert material defined in claim 1;
(b) bringing the inert material impregnated with water into contact with air at a temperature of between 10° C. and 80° C.;
(c) transporting the enriched air from step (b) into a condensation chamber, whereby the air is cooled to between 5° C. and 40° C., but at least by 5° C.;
(d) condensing, in the condensation chamber, of the water absorbed in the air; and
(e) collecting the condensed water.

11. Method according to claim 10, whereby the inert material impregnated with water has air passed through it in step (b) at a flow rate of between 0.1 μm/s and 100 m/s.

12. Method according to claim 11, whereby the flow rate of the air is between 2 m/s and 50 m/s.

13. Method according to claim 10, whereby the temperature of the air in step (b) is between 30° C. and 60° C.

14. Apparatus for the reduction of the salt content in aqueous solutions, comprising a container (4) accommodating the inert material defined in claim 1, whereby the container (4) is provided with an opening for feeding in air, a device for feeding the aqueous solution to the porous material and with an opening for removing the air (5), and whereby the opening for removing the air is linked to a condensation chamber (6) equipped with apparatus for condensing and collecting the water (7).

15. Apparatus according to claim 14, whereby a blower (1) is provided for the air supply.

16. Apparatus according to claim 14, whereby for the feeding of the aqueous solution, a supply container (2) is provided.
